(19) United States
(12) Patent Application Publication
(10) Pub. No.: US 2018/0120096 A1
(43) Pub. Date: May 3, 2018

(54) PROCESS FOR NON-DESTRUCTIVE TESTING USING DIRECT STRAIN IMAGING

(71) Applicant: Aerojet Rocketdyne, Inc., Sacramento, CA (US)

(72) Inventor: August Hugo Kruesi, Centreville, VA (US)

(21) Appl. No.: 15/572,814

(22) PCT Filed: Aug. 4, 2016
(86) PCT No.: PCT/US2016/045463

§ 371 Date: Nov. 9, 2017

Related U.S. Application Data
(60) Provisional application No. 62/209,148, filed on Aug. 24, 2015.

(51) Int. Cl. G01B 11/16; G01L 1/24; G01N 3/02

(52) U.S. Cl. CPC G01B 11/16; G01L 1/241; G01N 2203/0652; G01N 2203/0647; G01N 3/02

(57) ABSTRACT

A process for non-destructive testing includes applying a photo-curable dye to a surface of an article, selectively curing an array of dots of the photo-curable dye on the surface, removing the photo-curable dye that has not been selectively cured, mechanically testing the article, and direct strain imaging the article during the mechanical testing based on the array of dots.

### REFERENCE TO RELATED APPLICATIONS

This application claims priority to U.S. Provisional Application No. 62/209,148 filed on Aug. 24, 2015.

### BACKGROUND

Mechanical strain measurements are often conducted for materials testing, for example. On the most basic level mechanical strain measurement involves permanently deforming a test piece and then measuring how much the test piece deformed in order to determine strain. Of course, such a measurement technique destroys the test piece.

Strain can also be measured via imaging. For example, a marker is placed on a flat test coupon of material. An initial image of the marker is taken with the test coupon at rest. The test coupon is then subjected to a mechanical force and a second image of the marker is taken. Strain is determined by the difference in the location of the marker between the initial image and the second image.

### SUMMARY

A process for non-destructive testing according to an example of the present disclosure includes applying a photo-curable dye to a surface of an article, selectively curing an array of dots of the photo-curable dye on the surface, removing the photo-curable dye that has not been selectively cured, mechanically testing the article, and direct strain imaging the article during the mechanical testing based on the array of dots.

In a further embodiment of any of the foregoing embodiments, the array of dots includes a first array and a second array. The first array has a first pitch and the second array has a second pitch different than the first pitch.

In a further embodiment of any of the foregoing embodiments, the article is an additive manufactured article.

In a further embodiment of any of the foregoing embodiments, the surface of the article includes a joint.

In a further embodiment of any of the foregoing embodiments, the selective curing is conducted by a laser.

In a further embodiment of any of the foregoing embodiments, for each dot of the array of dots, the laser is oriented normal to the surface.

In a further embodiment of any of the foregoing embodiments, the laser is mounted on a robotic device configured to move relative to the part according to computer instructions.

In a further embodiment of any of the foregoing embodiments, the applying of the photo-curable dye to the article includes applying a film of the photo-curable dye.

In a further embodiment of any of the foregoing embodiments, the surface is in an internal cavity of the article.

In a further embodiment of any of the foregoing embodiments, the article is formed of solid rocket propellant.

An article for non-destructive testing according to an example of the present disclosure includes an article body that has a surface, and an array of dots disposed on the surface. The array of dots are formed of a photo-cured dye and configured for direct strain imaging.

In a further embodiment of any of the foregoing embodiments, the array of dots includes a first array and a second array. The first array has a first pitch and the second array has a second pitch different than the first pitch.

In a further embodiment of any of the foregoing embodiments, the article body defines an internal cavity, and the surface is in the internal cavity.

In a further embodiment of any of the foregoing embodiments, the article body is formed of solid rocket propellant.

In a further embodiment of any of the foregoing embodiments, the article body is additive manufactured.

In a further embodiment of any of the foregoing embodiments, the article body includes a joint.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example process for non-destructive testing.

FIG. 2 illustrates an example of first and second arrays of dots having different pitch.

FIG. 3 illustrates an article with an internal surface having an array of dots for direct strain imaging.

FIG. 4A illustrates an example of curing a dye using a source mounted on a robotic device.

FIG. 4B illustrates an orientation of the source relative to the local surface of the article.

### DETAILED DESCRIPTION

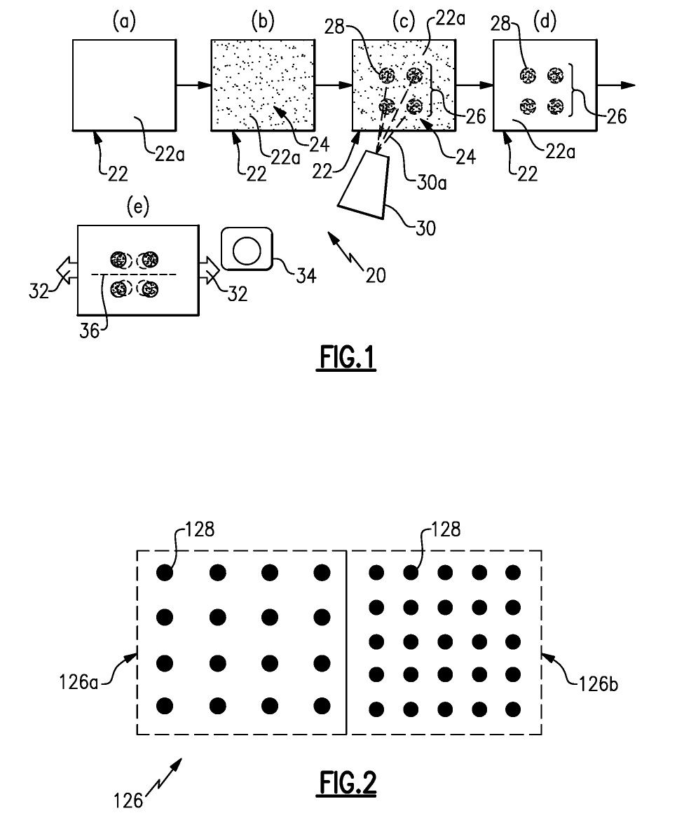

FIG. 1 schematically illustrates a process 20 for non-destructive testing using direct strain imaging. While basic strain imaging is known, it is not currently suited for high volume testing, manufactured articles, or complex geometries. As will be described, the process 20 provides the ability to rapidly prepare articles for direct strain imaging, is compatible for use with manufactured articles, and can be used with articles having complex shapes.

The process 20 is described with respect to stages (a), (b), (c), (d), and (e), although it is to be understood that stages may represent combined method actions or may be combined or further sub-divided. Stage (a) begins with an article 22 (article body) that is to be non-destructively tested. Such non-destructive testing may be conducted for a variety of reasons, including but not limited to quality assurance of manufactured articles, article design evaluation, finite element analysis validation, and article aging effects. The article 22 may be fabricated as part of the process 20, such as by additive manufacturing, or may simply be provided as a pre-fabricated part that is ready for the process 20.

At stage (b) a photo-curable dye 24 is applied to a surface or surfaces 22a of the article 22. The method of application may include, but is not limited to, dipping, spraying, and painting. The application technique may be selected to ensure coverage of the surface 22a of interest, including locations that may be difficult to access (e.g., notches, holes, grooves, etc.). In this example, the dye 24 forms a film on the surface 22a. As an example, the photo-curable dye 24 is a dye that is curable by electromagnetic radiation, typically ultraviolet radiation. Such dyes may include a constituent that is activated by exposure to ultraviolet or other radiation to initiate a polymerization reaction (curing). The surface 22a that receives the photo-curable dye 24 may be an exterior surface of the article 22 or an internal surface, such as the surface of an internal cavity or passage. In some examples, the photo-curable dye 24 is applied to all or substantially all of the exposed surfaces of the article 22.

Stage (c) involves selectively curing an array 26 of dots 28 of the dye 24 on the surface 22a. For instance, the dots 28 may be, but are not limited to, circular dots or elongated dots. An electromagnetic radiation source 30, such as a laser, is used to emit a photo-beam 30a onto pre-selected locations on the surface 22a, thereby curing the dye 24 only at those locations. Thea source 30 or laser may be moved, either manually or robotically, over the surface 22a between the pre-selected locations. The source or laser is activated only at the pre-selected locations to cure the dye 24. The remainder of the dye 24 that is not cured is removed at stage (d). The uncured dye 24 may be removed by wiping, rinsing in a solvent, evaporation, or a combination of these. A benefit of using the photo-beam 30a is that later during direct strain imaging, error in centroid determination, which would otherwise affect the accuracy of the strain computations, can be minimized due to the precision of the this curing technique. The precision may be enhanced by robotic aiming according to a CAD file, structured light surface measurements, etc., by creating reflective dot geometries which follow part contours rather than crossing features such as build ridges, fiber composite band ridges, and the like.

The array 26 of dots 28 of cured dye remain on the surface 22a. The configuration of the array 26 may be selected based on the geometry of the surface 22a, an expected load path, or the expected weak points of the article 22, for example. The array 26 may have pattern. For example, the pattern may be a square grid with a constant pitch. In another example, the array 26 may have an elliptical distribution.

As shown in stage (e), the article 22 with the array 26 of dots 28 is then mechanically tested as represented at arrows 32. The mechanical testing subjects the article 22 to stresses, which may be low stresses that do not permanently deform the article 22. The mechanical testing may include, but is not limited to testing that induces stress from thermal gradients, internal pressurization, and/or mechanical loads. The stresses induce a strain in the article 22. In some examples, the strain may be as low as 20 to 30 microstrain. The article 22 is subjected to direct strain imaging during the mechanical testing based on the array 26 of dots 28. For instance, a camera 34 is used to take an image of the array 26 of dots 28 with the article 22 at rest prior to the mechanical testing. One or more images of the array 26 of dots 28 are also taken during the mechanical testing. The positions of the dots 28 can be accurately determined from the images. For example, the positions of the dots 28 are determined by the centroids of the dots 28. The positions can then be compared between the images to measure how much, and in what directions, the dots 28 have moved due to the applied stress. The measurement and comparison of the dots 28 may be conducted by a computer or computer program configured to sense the locations of the dots 28 from the images.

The dye 24 may be selected such that the dots 28 have properties that enable detection. For example, the dots 28 may have a color, geometry, size, thickness, composition, saturation, reflectivity, refractivity, or combinations of these properties that is/are selected in accordance with the sensing capability of a direct strain imaging system or sensor.

The process 20 provides the potential to rapidly conduct direct strain imaging on articles of complex geometry, with high repeatability. For example, it may only take a few seconds for the curing in stage (c), and the dots 28 can thereby be rapidly applied to the article 22. The application of the dots 28 is also relatively insensitive to surface roughness, potentially making the process 20 compatible with many types of articles, materials (e.g., alloy articles, additively manufactured articles, composite articles, articles formed of solid propellant, etc.) and manufacturing processes. The process 20 may thus be used as a quality assurance measure in a manufacturing setting to non-destructively test manufactured articles. In particular, additively manufactured articles may benefit from the process 20. Moreover, it may be feasible to test up to 100% of the manufactured articles due to the speed and accuracy of the process 20.

The process 20 can also be used for article design evaluation and finite element analysis validation. For instance, the process can be used on prototype parts to evaluate complex strain responses and load paths and/or to check estimated strain responses conducted by finite element analysis. As an example, the array 26 of dots 28 may be applied across a joint, represented at 36. The joint 36 may be a bonded joint, a bolted joint, a threaded joint, or the like. The process 20 is then used to determine strain behavior across the joint 36 in response to applied stress in the mechanical testing.

The process 20 can also be used for component health monitoring to detect aging effects. For example, the article 22 may be a solid rocket propellant in a solid rocket motor. Typically, a solid propellant includes a solid oxidizer, a solid fuel, a binder system that holds the solid oxidizer and the solid fuel together, and optionally performance additives and stabilizers. Solid propellant can age prior to use, such as while a solid rocket motor is in storage for an extended period of time. As an example, exposure to oxygen (air), water moisture (in air), and nitrogen (air) in the environment can lead to reactions that may change the composition of the solid propellant and/or the chemistry of one or more constituents of the solid propellant. These changes may also induce strain in the solid propellant. The process 20 can be used to apply the array 26 of dots 28 to the solid propellant and, from time-to-time, direct strain imaging can be conducted to measure the strain in order to evaluate aging.

Referring to FIG. 2, another example array 126 of dots 128 is shown. In this disclosure, like reference numerals designate like elements where appropriate and reference numerals with the addition of one-hundred or multiples thereof designate modified elements that are understood to incorporate the same features and benefits of the corresponding elements. In this example, the array 126 includes a first array 126a and a second array 126b. The first array 126a has a first pitch and the second array 126b has a second pitch different than the first pitch. For example, the “pitch” is the concentration of dots 128 per unit length or per unit area. Although there are other nomenclatures, dots-per-inch is one example of pitch.

The first array 126a and the second array 126b may be adjacent each other on the article 22 or may be separated from each other. The arrays 126a/126b may be used to measure different magnitudes of strain in different locations of the article 22, for example.

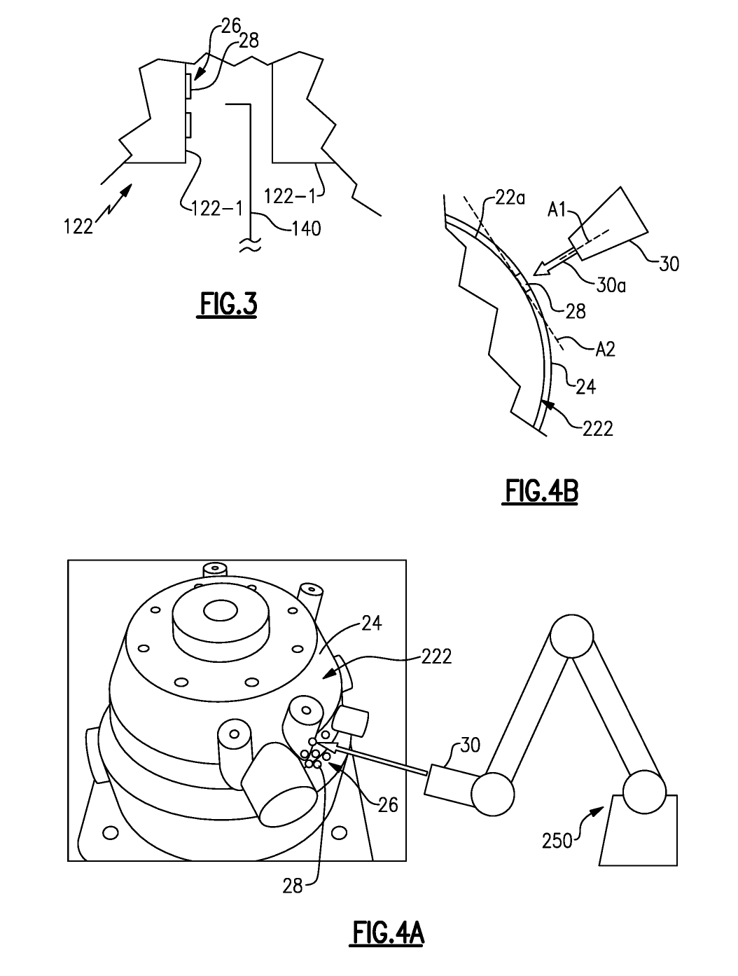

As described above, the array 26 (or 126) of dots 28 (or 128) may be used on exterior or interior surfaces of an article. FIG. 3 illustrates an article 122 that has an exterior surface 122-1 and an internal surface 122-2. For instance, the internal surface 122-2 is a surface of an internal cavity or passage of the article 122. In this example, the array 26 of dots 28 has been applied to the interior surface 122-2. For imaging, a fiber optic 140 may be used if the region around the array 26 of dots 28 does not permit a camera or camera element. Additionally or alternatively, optical reflectors or prisms may be used to take an image of the array 26 of dots 28.

FIGS. 4A and 4B illustrates a further example of stage (c) of the process of curing the dye 24. In this example, the electromagnetic radiation source 30, such as a laser, is mounted on a robotic device 250. The robotic device 250 is configured to move relative to the article 222 according to computer instructions. For instance, the article 222, with the dye 24 applied, is fixed in a known position. The robotic device 250 is programmed to move about the article 222 and cure the dye 24 at pre-programmed locations on the article 222. Additionally, as shown in FIG. 4B, the robotic device 250 may orient the source 30 or laser normal or substantially normal to the surface 22a at the location where the dot 28 is to be cured. That is, the axis A1 of the photo-beam 30a is perpendicular or substantially perpendicular to the tangent line A2 of the surface 22a at the location of the dot 28. Such an orientation facilitates formation of a uniform, circular dot. A similar robotic device with one or more mounted cameras or fiber optics may be used for imaging.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. A process for non-destructive testing, the process comprising:
applying a photo-curable dye to a surface of an article;
selectively curing an array of dots of the photo-curable dye on the surface;
removing the photo-curable dye that has not been selectively cured;
mechanically testing the article; and
direct strain imaging the article during the mechanical testing based on the array of dots.

2. The process as recited in claim 1, wherein the array of dots includes a first array and a second array, the first array having a first pitch and the second array having a second pitch different than the first pitch.

3. The process as recited in claim 1, wherein the article is an additive manufactured article.

4. The process as recited in claim 1, wherein the surface of the article includes a joint.

5. The process as recited in claim 1, wherein the selective curing is conducted by a laser.

6. The process as recited in claim 5, wherein, for each dot of the array of dots, the laser is oriented normal to the surface.

7. The process as recited in claim 5, wherein the laser is mounted on a robotic device configured to move relative to the part according to computer instructions.

8. The process as recited in claim 1, wherein the applying of the photo-curable dye to the article includes applying a film of the photo-curable dye.

9. The process as recited in claim 1, wherein the surface is in an internal cavity of the article.

10. The process as recited in claim 1, wherein the article is formed of solid rocket propellant.

11. An article for non-destructive testing, comprising:
an article body having a surface; and
an array of dots disposed on the surface, the array of dots being formed of a photo-cured dye and configured for direct strain imaging.

12. The article as recited in claim 11, wherein the array of dots includes a first array and a second array, the first array having a first pitch and the second array having a second pitch different than the first pitch.

13. The article as recited in claim 11, wherein the article body defines an internal cavity, and the surface is in the internal cavity.

14. The article as recited in claim 11, wherein the article body is formed of solid rocket propellant.

15. The article as recited in claim 11, wherein the article body is additive manufactured.

16. The article as recited in claim 11, wherein the article body includes a joint.
